(19) United States
(12) Patent Application Publication
(10) Pub. No.: US 2013/0333526 A1
(43) Pub. Date: Dec. 19, 2013

(54) SPEED MECHANISM FOR SCREW DRIVER

(71) Applicant: YU-LUN CHEN, TAINAN CITY (TW)

(72) Inventor: YU-LUN CHEN, TAINAN CITY (TW)

(73) Assignee: GONG FONG ENTERPRISE CO., LTD., TAINAN CITY (TW)

(21) Appl. No.: 13/517,671

(22) Filed: Jun. 14, 2012

(51) Int. Cl. B25B 15/04

(52) U.S. Cl. 81/63.1

(57) ABSTRACT

A screw driver includes a body having a ratchet unit and a first transmission rod extends through the ratchet unit. The first transmission rod has a ratchet gear and a switch member is connected to the ratchet unit to control the operation status of the ratchet gear. The first transmission rod has a tube connected to a first end thereof and a non-circular connection portion is connected to a second end of the first transmission rod. A handle is connected to the body and has a toothed ring located therein. The toothed ring is engaged with a planet gear unit which is engaged with a sun gear mounted to a second transmission rod which has an accommodating portion. The accommodating portion is engaged with the connection portion. The individual first and second transmission rods do not generate resistance when the screw driver operates the objects at high speed.

### FIELD OF THE INVENTION

The present invention relates to a speed mechanism for a screw driver, and more particularly, to a speed mechanism having first and second transmission rods which are not tilted when spinning at high speed so that the resistance is reduced.

### BACKGROUND OF THE INVENTION

A conventional screw driver can tighten and loosen bolts, but it cannot increase the driving speed.

Taiwan Patent Publication No. 533956 discloses a screw driver which has a handle, a sleeve, a shank, a ring, a knob and a plant gear unit. The handle is a hollow part and has a circular top portion and teeth are formed along the periphery of the top portion. A sleeve is inserted into the underside of the handle. The shank is connected to the handle and has a screw bit at the end which extends through the sleeve. The shank has a block and a gear connected thereto so as to form an extension end. A ring is mounted to the stepped portion on the block. The top portion of the handle has a knob which is connected to three planet gears on the underside thereof. The planet gears are engaged with and located between the toothed ring and the gear. The axles of the planet gears are located in the hole of the ring. The knob has a central hole in which a bead is located. The extension end of the shank extends through the central hole so as to rotate the knob. The planet gears are rotatably engaged with the toothed ring and spin themselves about the axles. Therefore, the gear slows down by the planet gears and the shank is co-rotated to operate the object.

However, the gear unit cannot change the operational direction of the hand tool and cannot set the operational direction of the hand tool. This cannot satisfy the requirements of the users.

The lack of the positioning feature may cause the gear unit to operate in opposite direction by mistake operation from the users. This reduces the efficiency and increases the inconveniences.

Applicant has invented a hand tool which is disclosed in Taiwan Patent Publication No. M347252 and comprises a ratchet unit and a sun gear unit, wherein the ratchet unit ensures that the operational direction is set and the sun gear unit increases the output speed to conveniently loosen or tighten the objects.

The sleeve has the sun gear at the first end thereof and multiple planet gears are engaged with the sun gear. The second end of the sleeve is connected with a screw bit. By the operation of the planet gears and the sun gear, the screw bit can loosen or tighten the objects at high speed. However, because the sleeve is a long sleeve and when the first end is applied a force, the second end may shift off from the central line when the force is transmitted to the second end. Therefore, significant resistance is generated from the objects and may damage the objects.

The present invention intends to provide a speed mechanism for a screw driver for improving all of the shortcomings of the conventional screw drivers.

### SUMMARY OF THE INVENTION

The present invention relates to a screw driver and comprises a body having a ratchet unit and a first transmission rod extends through the ratchet unit. The first transmission rod has a ratchet gear and a switch member is connected to the ratchet unit to control the ratchet gear to rotate clockwise, counterclockwise or stop. The first transmission rod has a first end and a second end. The first end has a tube connected thereto and the second end is connected with a non-circular connection portion. A handle is connected to the body and has a toothed ring located therein. The toothed ring is engaged with a planet gear unit which is engaged with a sun gear. The sun gear is mounted to a second transmission rod which has an accommodating portion so as to be engaged with the connection portion.

Preferably, the connection portion is a hexagonal portion and the accommodating portion is shaped to be engaged with the connection portion.

Preferably, the accommodating portion has a circular bead received therein which contacts the first transmission rod.

The primary object of the present invention is to provide a speed mechanism for a screw driver, wherein the individual first and second transmission rods are connected to each other and do not generate resistance when the screw driver operates the objects at high speed.

The speed mechanism for the screw driver allows the user to choose the high-speed operation mode with low torque or low-speed operation mode with high torque.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the screw driver with the speed mechanism of the present invention;

FIG. 2 is a cross sectional view to show the screw driver with the speed mechanism of the present invention;

FIG. 3 is an exploded view to show the speed mechanism of the present invention;

FIG. 4 is a cross sectional view taken along line B-B of FIG. 1, and

FIG. 5 is a cross sectional view taken along line C-C of FIG. 1.

### DETAILED DESCRIPTION OF THE PREFERRED EMBODIMENT

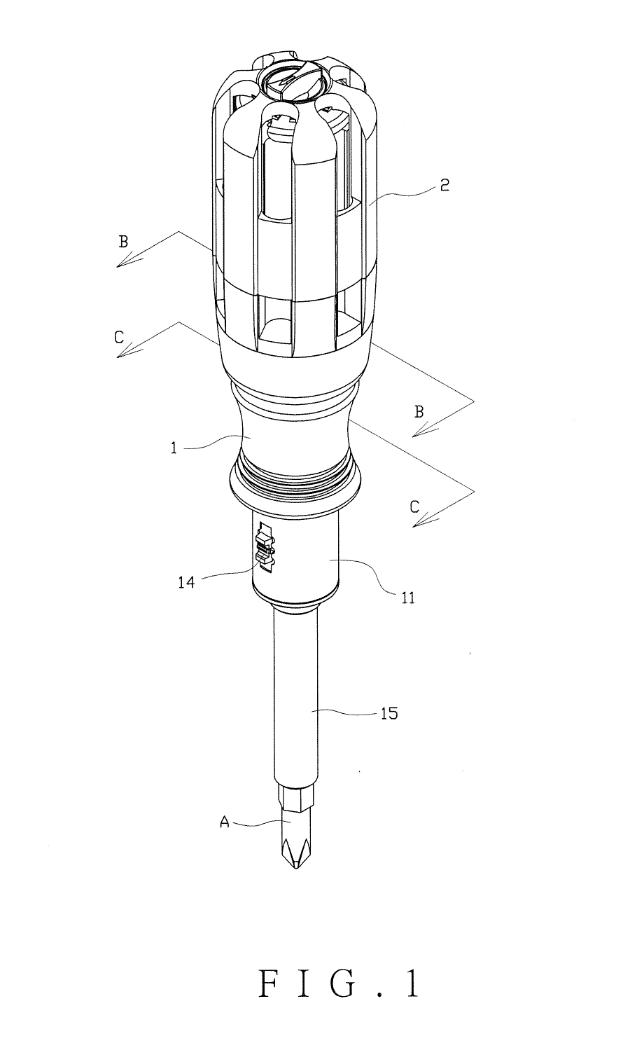

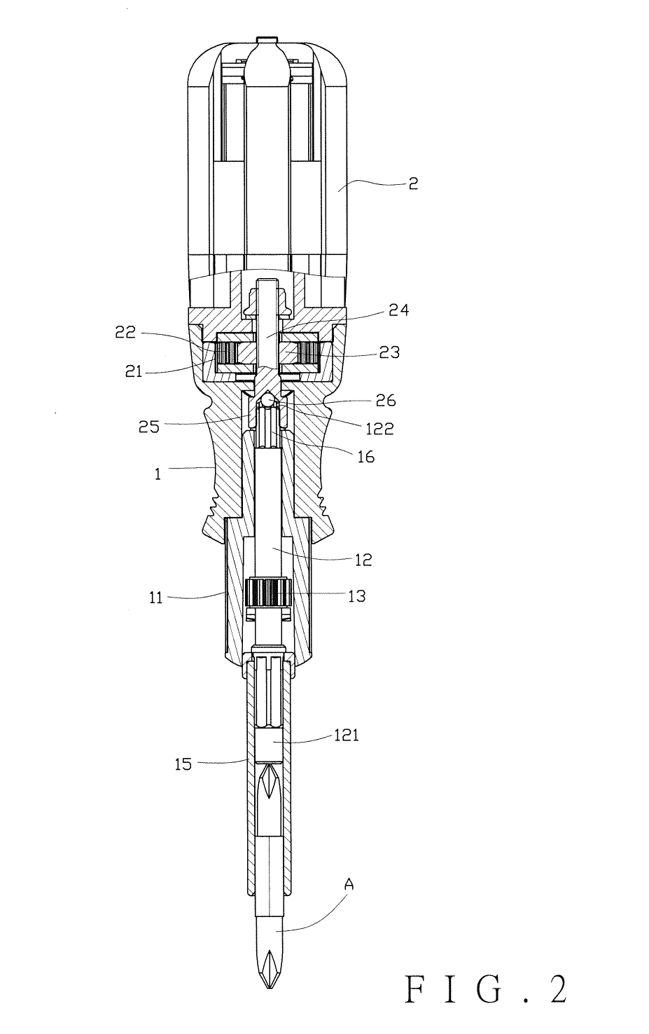

Referring to FIGS. 1 and 2, the screw driver of the present invention comprises a body 1 and a handle 2.

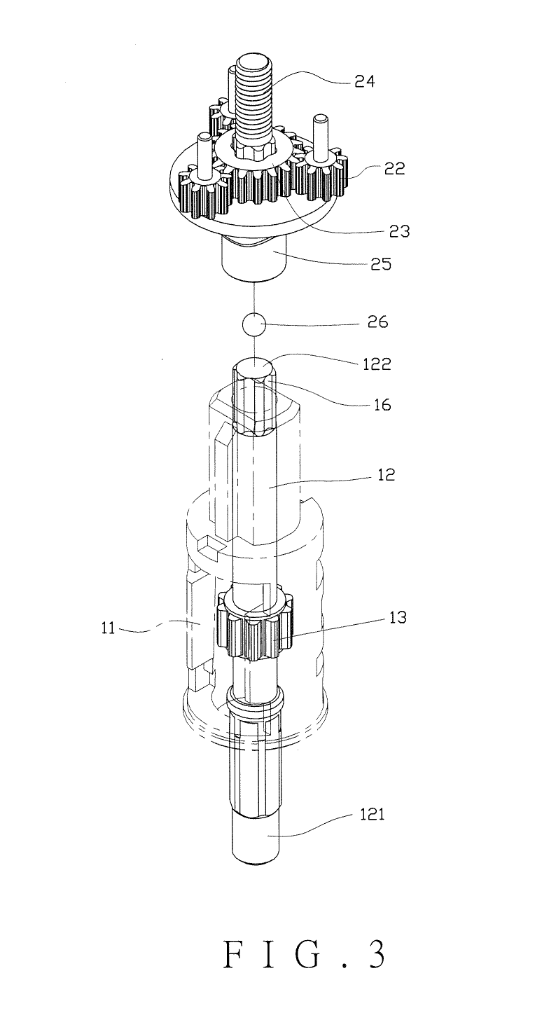

The body 1 has a ratchet unit 11 and a first transmission rod 12 extends through the ratchet unit 11. The first transmission rod 12 has a ratchet gear 13 as shown in FIG. 3. A switch member 14 is connected to the ratchet unit 11 so as to control the ratchet gear 13 to rotate clockwise, counterclockwise or stop. The first transmission rod 12 has a first end 121 and a second end 122, wherein the first end 121 has a tube 15 connected thereto and a screw bit “A” is connected to the tube 15. The second end 122 is connected with a non-circular connection portion 16 which is a hexagonal portion in this embodiment.

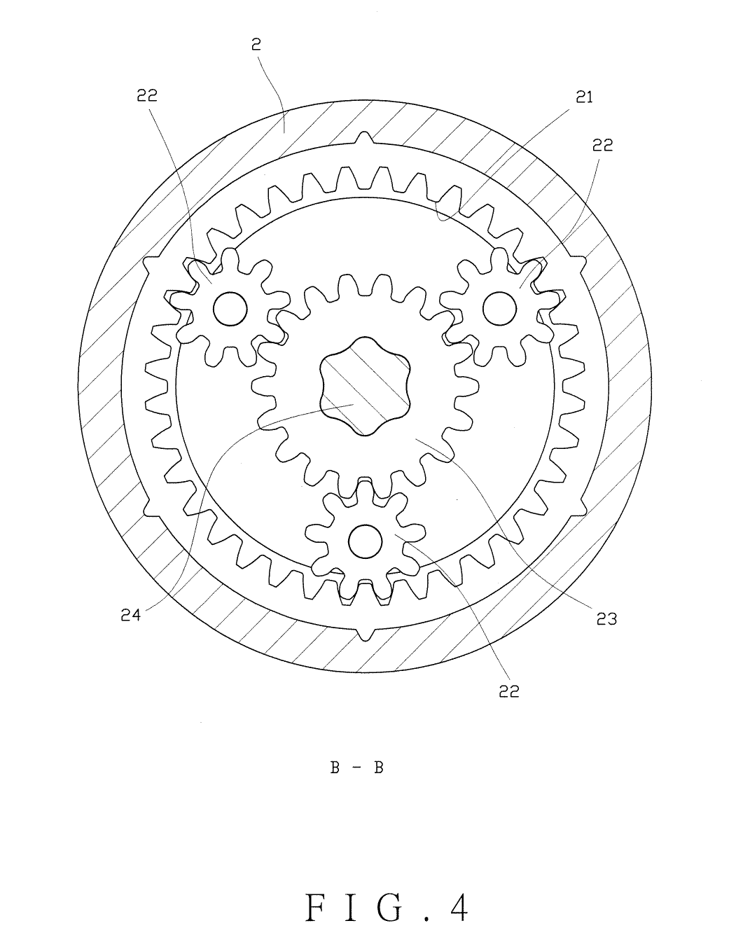

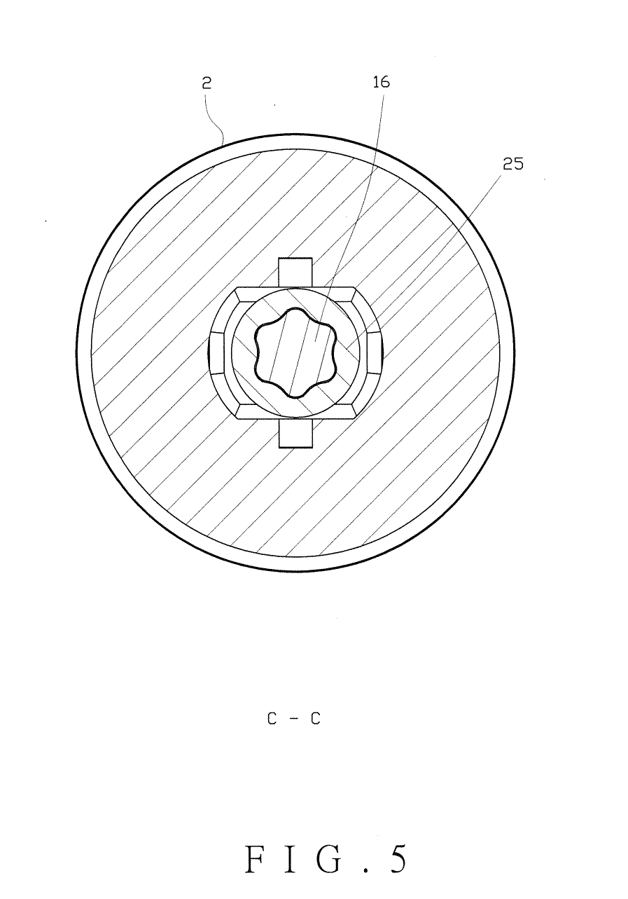

The handle 2 is connected to the body 1 and has a toothed ring 21 located therein as shown in FIG. 4. The toothed ring 21 is engaged with a planet gear unit 22 which is engaged with a sun gear 23. The sun gear 23 is mounted to a second transmission rod 24 which has an accommodating portion 25 (as shown in FIG. 5) so as to be engaged with the connection portion 16. The accommodating portion 25 is shaped to be engaged with the connection portion 16 and a circular bead 26 is located in the accommodating portion 25 and contacts the first transmission rod 12.

When in use, as shown in FIGS. 1 and 2, the screw bit “A” is connected to the tube 15. When high speed and low torque is required to tighten the object, the switch member 14 on the ratchet unit 11 is pushed to choose the ratchet wheel 13 to rotate clockwise or counterclockwise. The user then holds the handle 2 and rotates the handle 2 clockwise as shown in FIG. 4. The planet gear unit 22 rotates along the toothed ring 21 in the handle 2 and each of the gears of the planet gear unit 22 spins and rotates the sun gear 23 of the second transmission rod 24 which outputs clockwise. When the handle 2 rotates one revolution, the second transmission rod 24 rotates more than one revolution. The connection portion 16 of the first transmission rod 12 is rotated by the engagement with the accommodation portion 25, so that the first transmission rod 12 is rotated. The first transmission rod 12 is rotated by the control via the ratchet unit 11 to tighten the object by the screw bit “A”. When the object is almost tightened, low speed and high torque is required. The user then operates the switch member 14 to choose the ratchet wheel 13 to stop and the first transmission rod 12 is then stopped. When the handle 2 rotates, the toothed ring 21 is not engaged with the planet gear unit 22 to drive the sun gear 23 to rotate at high speed. Therefore, the second transmission rod 24 is co-rotated with the handle 2 by the engagement between the connection portion 16 and the accommodation portion 25. The first transmission rod 12 rotates at low speed and high torque. To further tighten the object by the screw bit “A”. The present invention can be operated at high speed and low torque to quickly rotate the object at the beginning of tightening the object, and when the object is almost tightened, the output is changed to be low speed and high torque to securely tighten the object.

While we have shown and described the embodiment in accordance with the present invention, it should be clear to those skilled in the art that further embodiments may be made without departing from the scope of the present invention.

What is claimed is:

1. A screw driver comprising:
a body having a ratchet unit and a first transmission rod extending through the ratchet unit, the first transmission rod having a ratchet gear, a switch member connected to the ratchet unit to control the ratchet gear to rotate clockwise, counterclockwise or stop, the first transmission rod having a first end and a second end, the first end having a tube connected thereto and the second end connected with a non-circular connection portion, and
a handle connected to the body and having a toothed ring located therein, the toothed ring engaged with a planet gear unit which is engaged with a sun gear, the sun gear mounted to a second transmission rod which has an accommodating portion which is engaged with the connection portion.

2. The screw driver as claimed in claim 1, wherein the accommodating portion has a circular bead received therein which contacts the first transmission rod.

3. The screw driver as claimed in claim 1, wherein the connection portion is a hexagonal portion and the accommodating portion is shaped to be engaged with the connection portion.

4. The screw driver as claimed in claim 3, wherein the accommodating portion has a circular bead received therein which contacts the first transmission rod.
